(19) United States
(12) Patent Application Publication
(10) Pub. No.: US 2005/0105259 A1
(43) Pub. Date: May 19, 2005

(54) Display apparatus

(75) Inventors: Kyung-kyun Lee, Seoul (KR); Kwey-hyun Kim, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/948,735

(22) Filed: Sep. 24, 2004

(30) Foreign Application Priority Data
Nov. 15, 2003 (KR) 2003-78053

(51) Int. Cl. G06F 1/16

(52) U.S. Cl. 361/681; 248/917; 345/905

(57) ABSTRACT

A display apparatus having: a display panel display a picture; a front casing provided in a front of the display panel; a rear casing provided in a rear of the display panel and coupled with the front casing; and a top cover provided on a top of the display panel in a predetermined angle to the front casing, and having a plurality of discharging holes positioned therethrough. As described above, the display apparatus has an improved heat discharging efficiency to discharge heat radiated from the display apparatus rapidly, and a slim external appearance.

### CROSS-REFERENCE TO RELATED APPLICATION

This application claims the benefit of Korean Patent Application No. 2003-78053, filed Nov. 5, 2003 in the Korean Intellectual Property Office, the disclosure of which is incorporated herein by reference.

### BACKGROUND OF THE INVENTION

1. Field of the Invention

The present invention relates to a display apparatus, and more particularly, to a display apparatus capable of improving heat discharging efficiency, to discharge heat radiated from the display apparatus rapidly and maintain a slim external appearance.

2. Description of the Related Art

Generally, a display apparatus refers to an apparatus that displays a picture, such as a TV or a computer monitor, as a whole. The display apparatus comprises a display panel displaying a picture, and a casing supporting the display panel.

As is shown in FIGS. 7 and 8, a display apparatus 101 comprises a display panel 123 displaying a picture with a display component such as a liquid crystal display (LCD) or a plasma display panel (PDP), and front and rear casings 110 and 130 supporting the display panel 123 in a front and rear thereof, respectively.

The front casing 110 has a plurality of bosses 180 on an inside thereof. The rear casing 130 has a plurality of corresponding coupling holes 181 formed through a surface thereof, so that a plurality of corresponding screws 182 can pass through the coupling holes 181 and be coupled to the bosses 180 of the front casing 110. The rear casing 130 also has a plurality of discharging holes 134 to discharge the heat radiated from the inside of the display apparatus 101.

Hereinbelow, a process of assembling the display apparatus 101 shown in FIGS. 7 and 8 will be described.

Firstly, the display panel 123 is positioned such that a displaying surface of the display panel 123 faces the front casing 110. The rear casing 130 is positioned such that the coupling holes 181 formed on the rear casing 130 and the bosses 180 positioned on the front casing 110 communicate with each other. In other words, the rear casing 130 is positioned such that the coupling holes 181 and the bosses 180 are positioned on the same axis line. Accordingly, the assembly is completed as the screws 182 are coupled to the bosses 180 through the coupling holes 181 from the rear.

A recent trend in display apparatuses is maximizing a displaying area of the display panel and minimizing the thickness of the display apparatus. In such a trend, heat discharging efficiency, that is, efficiency of discharging the heat radiated from the inside of the display apparatus, becomes important. Accordingly, by providing a larger upper part of the front casing positioned on an upper side of the display panel, so that more discharging holes can be formed on the upper part of the front casing with a large surface area, heat discharging efficiency of the display apparatus can be improved by discharging the heat radiated from the inside of the display apparatus rapidly.

But it is not convenient to manufacture a front casing with larger area on an upper part to form more discharging holes on the upper side of the front casing. This inconvenience of manufacturing lowers productivity. Also, such a display apparatus does not have a slim external appearance because the thickness of the display apparatus substantially increases as the distance between the front casing and the rear casing increases due to the larger surface area on the upper side of the front casing.

If the upper side of the front casing is provided to be larger, the distance between the front casing and the rear casing increases. Accordingly, as is shown in FIGS. 7 and 8, it becomes difficult to couple the front casing 110 and the rear casing 130 in a structure in which the bosses 180 of the front casing 110 and the coupling holes 181 of the rear casing 130 should be positioned coaxially to communicate with each other.

Accordingly, it is preferable to provide a display apparatus having a structure with improved heat discharging efficiency by discharging the heat radiated from the inside of the display apparatus rapidly, and a slim external appearance at the same time. Also, it will be further preferable to solve inconvenience caused by coupling of the boss of the front casing and the coupling hole of the rear casing coaxially.

### SUMMARY OF THE INVENTION

Accordingly, it is an aspect of the present invention to provide a display apparatus, capable of improving heat discharging efficiency to discharge heat radiated from the display apparatus rapidly, with a slim external appearance.

Additional aspects and/or advantages of the invention will be set forth in part in the description which follows, and in part, will be obvious from the description, or may be learned by practice of the invention.

The foregoing and/or other aspects of the present invention are achieved by providing a display apparatus comprising: a display panel to display a picture; a front casing provided in a front of the display panel; a rear casing provided in a rear of the display panel and coupled with the front casing; and a top cover provided on a top of the display panel in a predetermined angle to the front casing, and having a plurality of discharging holes positioned therethrough.

According to an aspect of the invention, the display apparatus further comprises a coupling member provided between the front casing and the rear casing and coupled with the front casing and the rear casing.

According to an aspect of the invention, the display apparatus further comprises: at least one first boss positioned on an inner surface of an upper area of the front casing; and at least one second boss positioned on an inner surface of an upper area of the rear casing, positioned on an axis spaced from an axis of the first boss, wherein the coupling member is provided between the first boss and the second boss, so that a first part of the coupling member is coupled to the first boss and a second part of the coupling member is coupled to the second boss.

According to an aspect of the invention, the first part of coupling member comprises: a first coupler extending outward from a first side of the coupling member and having a first coupling hole positioned coaxially with the first boss to communicate with the first boss; and the second part of the coupling member comprises a second coupler provided on a second side of the coupling member, positioned on an axis spaced from an axis of the first coupling hole, and having a second coupling hole positioned coaxially with the second boss.

According to an aspect of the invention, the display apparatus further comprises a panel supporting member coupled with a circumferential area of the display panel, wherein the coupling member is provided plurally on an upper area of the panel support member along a longitudinal direction.

According to an aspect of the invention, the coupling member has a supporting groove configured such that the coupling members are coupled to an upper end of the panel supporting member.

According to an aspect of the invention, the top cover comprises a plurality of coupling flanges, each having an insertion hole positioned through a surface thereof, the plurality of coupling hinges being positioned along a circumferential area of the top cover contacting the rear casing, and the rear casing comprises a corresponding plurality of coupling protrusions, the plurality of coupling protrusions being inserted into and coupled with the respective insertion holes.

According to an aspect of the invention, the top cover comprises a coupling rib positioned on a surface of the top cover contacting the front casing, and the front casing comprises a rib accommodating part with which the coupling rib is coupled.

According to an aspect of the invention, the top cover is approximately shaped like a triangle, and a cross section of the rear casing is ‘V’-shaped, to correspond to a shape of the top cover.

According to an aspect of the invention, the front casing comprises: a front supporter having an opening exposing a displaying surface of the display panel to the outside; and a pair of flanges extending from opposite ends of the front supporter, respectively, and coupling with opposite side areas of the rear casing, respectively, wherein the pair of flanges are installed in a predetermined angle to the front supporter corresponding to a shape of the rear casing.

According to an aspect of the invention, the first boss is provided plurally on an inner surface of an upper area of the front supporter along a longitudinal direction, the first bosses being spaced from each other with a first predetermined interval.

### BRIEF DESCRIPTION OF THE DRAWINGS

The above and/or other aspects and advantages of the present invention will become apparent and more readily appreciated from the following description of the embodiments, taken in conjunction with the accompany drawings, of which:

FIG. 1 is a front perspective view of a display apparatus according to an embodiment of the present invention;

FIG. 2 is a rear perspective view of the display apparatus of FIG. 1;

FIGS. 3 and 4 are exploded perspective views of the display apparatus of FIG. 1;

FIGS. 5a and 5b are perspective views of a coupling member shown in FIG. 4;

FIG. 6 is a cut-off perspective view of an installing area of the coupling member shown in FIG. 4;

FIG. 7 is a rear perspective view of a conventional display apparatus; and

FIG. 8 is an exploded perspective view of the display apparatus of FIG. 7.

### DETAILED DESCRIPTION OF THE EMBODIMENTS

Reference will now be made in detail to the embodiments of the present invention, examples of which are illustrated in the accompanying drawings, wherein like reference numerals refer to like elements throughout. The embodiments are described below to explain the present invention by referring to the figures.

A display apparatus according to an embodiment of the present invention refers to an apparatus that displays a picture such as a TV, or a computer monitor as a whole, using an LCD or a PDR Hereinbelow, the embodiment of the present invention will be described with a display apparatus using the LCD panel as an example. But it is understood that other types of displays, including CRTs and OLEDs, can be used with this invention.

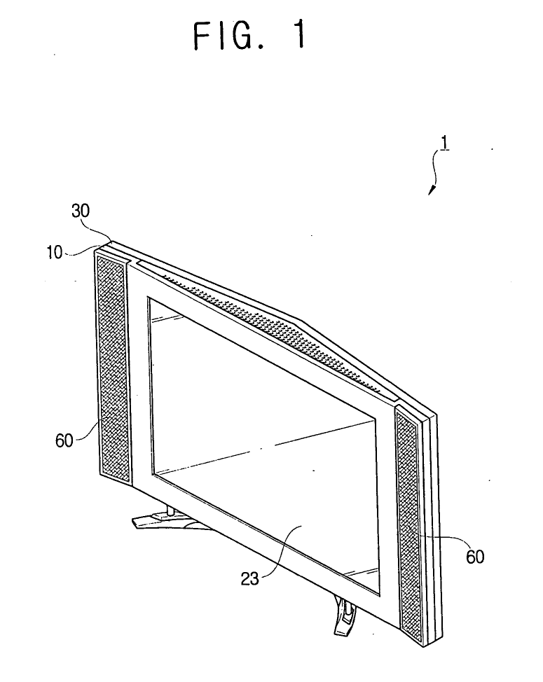

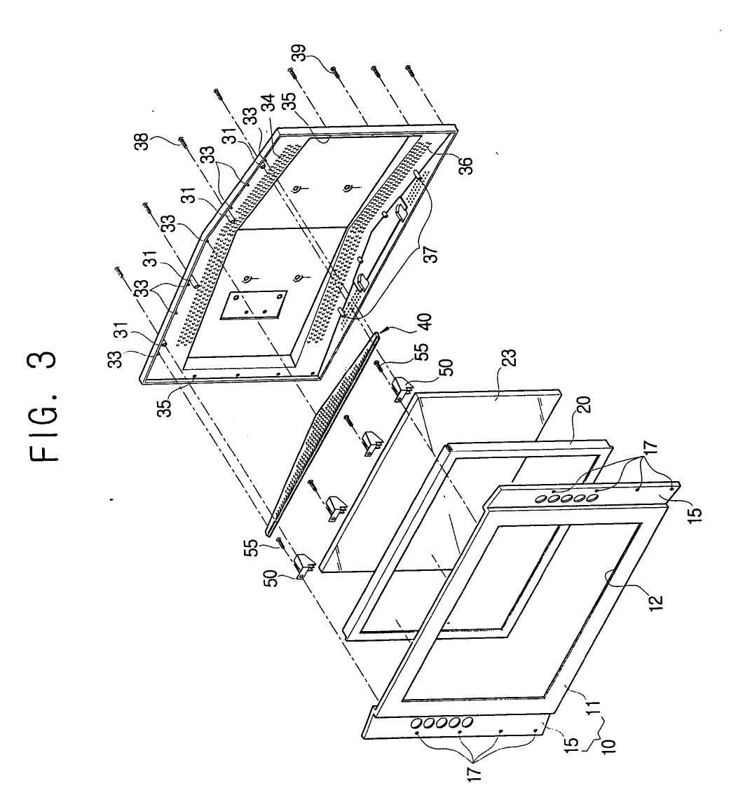

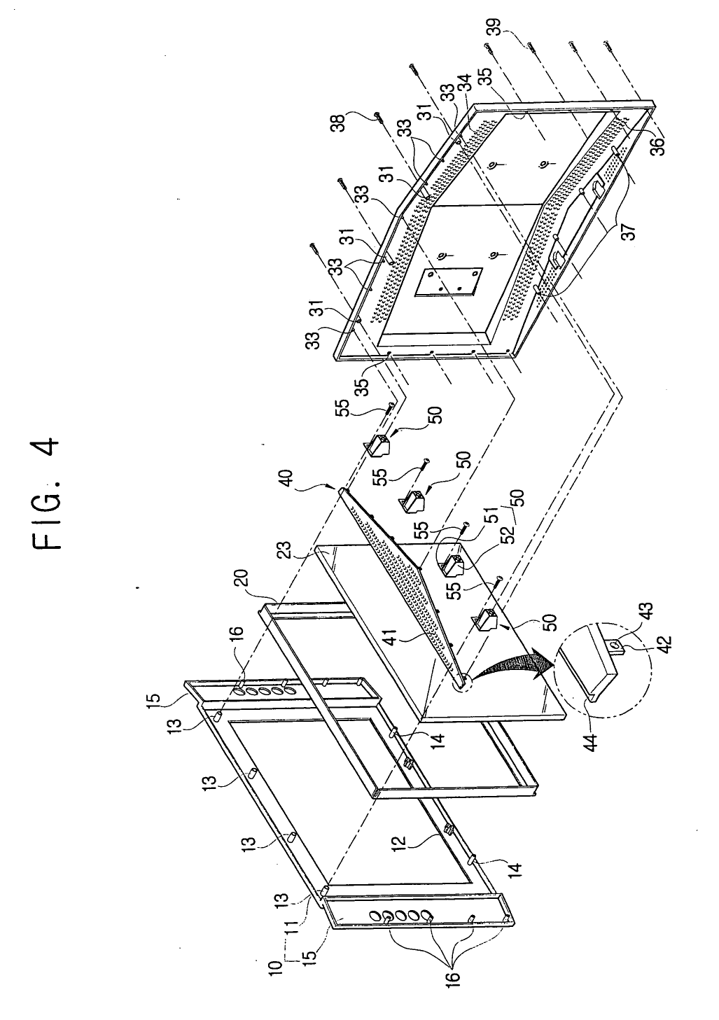

As is shown in FIGS. 1-6, a display apparatus 1 according to an embodiment of the present invention comprises an LCD panel 23 displaying a picture, a front casing 10 provided in a front of the LCD panel 23 and having an opening 12, through which a display surface of the LCD 23 is viewed. A panel supporting member 20 is coupled to a circumferential area of the LCD panel 23. A rear casing 30 is provided in a rear of the LCD panel 23 and is coupled with the front casing 10. A top cover 40 is provided between the front casing 10 and the rear casing 30 and is installed on the top of the LCD panel 23.

The front casing 10 comprises a front supporter 11 having the opening 12 to expose a displaying surface of the LCD panel 23, and a pair of flanges 15 extending from opposite ends of the front supporter 11, respectively. Each flange 15 is coupled to a speaker grill 60. But it is understood that other configurations are possible, and that the speaker grills 60 can be otherwise disposed or not used.

An inside of the front supporter 11 has a plurality of first bosses 13 provided along a longitudinal direction on an upper area centering the opening 12 and spaced from each other with a first predetermined interval. Also, a top of the front supporter 11 has a rib accommodating part 18, to which a coupling rib 44 of the top cover 40 can be coupled, and a plurality of front coupling protrusions 14, which are positioned along a longitudinal direction on a bottom area of the front supporter 11 centering the opening 12 while being spaced from each other with a second predetermined interval.

An inside of each first boss 13 is formed with female screw to be coupleable with a first screw 55 (i.e., male screw) inserted into a first coupling hole 53 positioned on a first coupling part of a coupling member 50. Each front coupling protrusion 14 is coupled to a protrusion accommodating boss 37 of the rear casing 30 as the front coupling protrusion 14 extends from an inner surface of the bottom area of the front supporter 11. While described in terms of screws, it is understood that other fasteners can be used, and that the male and female screws can be disposed on other opposing features.

The pair of flanges 15 is coupled to opposite side areas of the rear casing 30, respectively. Each flange 15 is recessed from a front surface of the front supporter 11, and is provided in a predetermined angle to the front surface of the front supporter 11.

As shown, the pair of flanges 15 is provided in an angle corresponding to the shape of the rear casing 30 so that the flanges 15 can couple with the opposite side areas of the rear casing 30. But other angles and shapes are possible, and it is understood that the flanges 15 need not be used in all aspects of the invention.

Each flange 15 is provided with a plurality of flange boss holes 17 positioned along a longitudinal direction and spaced from each other with third a predetermined interval. Also, a flange boss 16 extends from an inner surface of each flange 15 toward the rear casing 30 to correspond with each flange boss hole 17. Accordingly, as third screws 39 are coupled to the flange bosses 16 through side coupling holes 35 of the rear casing 30, each flange 15 can be coupled to each side area of the rear casing 30.

The panel supporting member 20 is coupled on a circumferential area of the LCD panel 23 and is installed on the front supporter 11 of the front casing 10. The coupling members 50 are provided along a longitudinal direction on an upper area of the panel supporting member 20, to fasten the member 20 and LCD panel 23 to the front supporter 11.

The rear casing 30 having a cross-section shaped like ‘V’ is provided in the rear of the LCD panel 23 and is coupled to the panel supporting member 20. An upper area of the rear casing 30 is provided with a plurality of second bosses 31, a rear coupling protrusion 33 and a plurality of rear heat discharging holes 34, while a lower area of the rear casing 30 is provided with a plurality of rear inflow holes 36, and a plurality of protrusion accommodating bosses 37. Each side area of the rear casing 30 is provided with the plurality of side coupling holes 35 along a longitudinal direction.

The plurality of second bosses 31 are provided along a longitudinal direction on an inner surface of an upper area of the rear casing 30 and spaced from each other with a fourth predetermined interval. An inner space of each second boss 31 communicates with a boss connecting hole 32 formed through the rear casing 30 on a position corresponding to each second boss 31. Accordingly, second screws 38 are inserted into the inner spaces of respective second bosses 31 through the boss connecting holes 32 to couple the rear casing 30 and second couplers 52 of the coupling members 50, so that the second screws 38 can be coupled to second coupling holes 54 of the second couplers 52. Herein, the second bosses 31 and the first bosses 13 do not communicate with each other because the second bosses 31 of the rear casing 30 are formed on an axes spaced from axes of the first bosses 13 of the front casing 10. But it is understood that the first and second bosses 13, 31 can be collinear, to reduce the number of fasteners used. It is also understood that the male/female screws can be positioned opposite to the manner shown.

The plurality of rear coupling protrusions 33 are provided along a longitudinal direction on an inner surface of an upper area of the rear casing 30 and are spaced from the plurality of second bosses 31 with a fifth predetermined interval. Each rear coupling protrusion 33 is inserted into an insertion hole 43 formed on a coupling flange 42 of the top cover 40 as the top cover 40 is coupled to a top area of the rear casing 30.

The rear heat discharging holes 34 are formed through a top area of the rear casing 30 to discharge the heat radiated from an inner space of the display apparatus 1, which is formed by the front and rear casings 30 and the top cover 40. -Accordingly, the rear heat discharging holes 34 and discharging holes 41 of the top cover 40 function to discharge air that flows through the rear inflow hole 36 formed on a bottom area of the rear casing 30 and is used for cooling the inner space, in which the LCD 23 and other electronics are disposed.

The plurality of protrusion accommodating bosses 37 are provided along a longitudinal direction on an inner surface of a bottom area of the rear casing 30 and are spaced from each other with the second predetermined interval. As the rear casing 30 and the front casing 10 are coupled, each front coupling protrusion 14 formed on the bottom area of the front supporter 11 of the front casing 10 is inserted and coupled to the respective protrusion accommodating boss 37.

The plurality of side coupling holes 35 are formed through surfaces of the side areas of the rear casing 30 along a longitudinal direction. On each side area, the coupling holes 35 are spaced from each other with a sixth predetermined interval. Accordingly, as the third screws 39 inserted into the side coupling holes 35 are coupled to the flange bosses 16 of the flange 15, the opposite side areas of the rear casing 30 are coupled to the pair of flanges 15 of the front casing 10.

The top cover 40 shaped like a triangle is provided on a top of the LCD panel 23 at a predetermined angle to a top surface of the front supporter 11. The top cover 40 has the plurality of discharging holes 41 to discharge the heat radiated from the inside of the display apparatus 1 rapidly. Herein, the discharging holes 41 are positioned on the top of the LCD panel 23 for the purpose of discharging the heat radiated from the inside of the display apparatus 1 rapidly. While shown as being triangularly shaped, it is understood that other shapes, such as curved and rectilinear shapes, can be used.

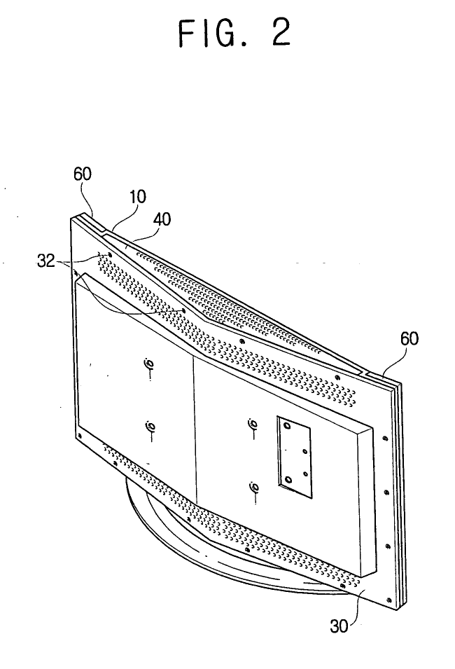

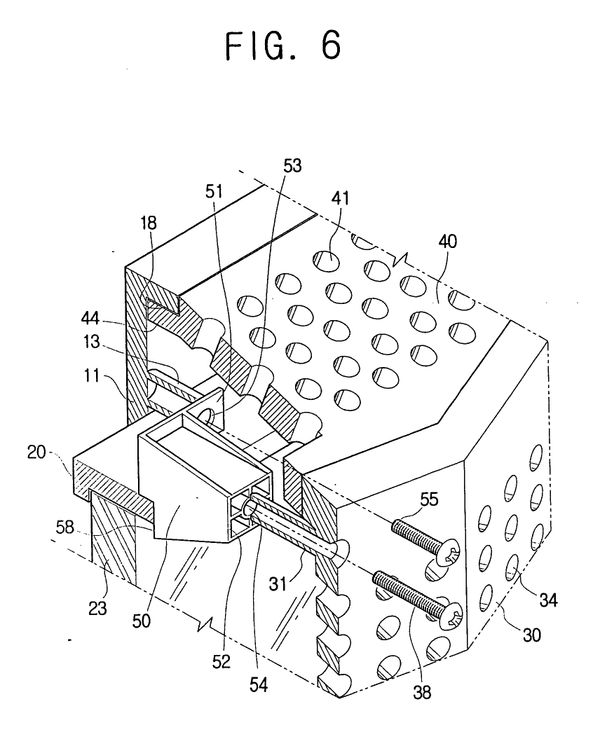

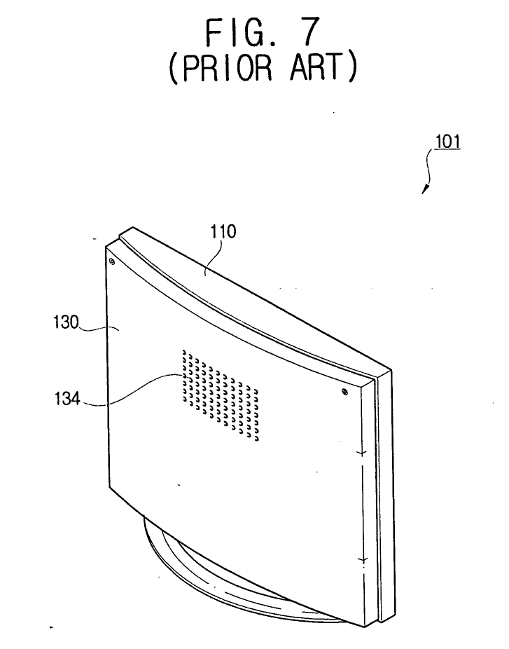

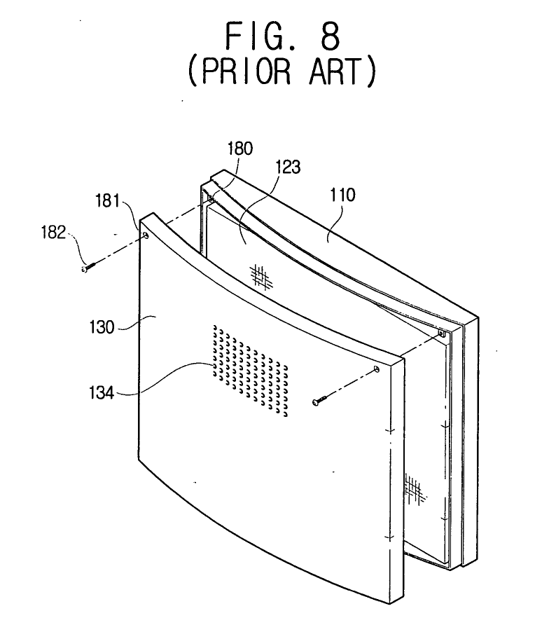

As the top cover 40 is formed with the plurality of discharging holes 41, the heat radiated from the inside of the display apparatus 1 can be discharged rapidly. Also, as the top cover 40 is provided in an angle to the front supporter 11, as is shown in FIG. 6, the thickness of the display apparatus 1 can be reduced, as is shown in FIGS. 1 and 2. But it is understood that the top cover 40 can be used at other angles, or that no angle need be used.

A circumferential area of the top cover 40 contacting the front casing 10 has the coupling rib 44 coupled to the rib accommodating part 18 positioned on the front supporter 11 of the front casing 10. A circumferential area of the top cover 40 contacting the rear casing 30 has the plurality of coupling flanges 42, respectively having the insertion holes 43, into which the rear coupling protrusions 33 of the rear casing 30 are coupled. While shown as a single coupling rib 44, it is understood that multiple ribs can be used to form a channel, into which the rib accommodating part 18 fits, and that other types of connections can be used. Moreover, it is understood that the coupling rib 44 need not be used in all aspects, and that the interface between the top cover 40 and the front supporter 11 can be accomplished using an adhesive.

Each coupling flange 42 extends downward from a rear surface of the top cover 40, and the insertion hole 43 is positioned through a surface of the respective coupling flange 42. Accordingly, as the rear casing 30 and the top cover 40 are coupled, the rear coupling protrusion 33 positioned on an inner surface of the upper area of the rear casing 30 is inserted into the insertion hole 43.

The display apparatus 1 according to the embodiment of the present invention further comprises a plurality of coupling members 50 provided on a bottom of the top cover 40 and coupling the front casing 10 and the rear casing 30.

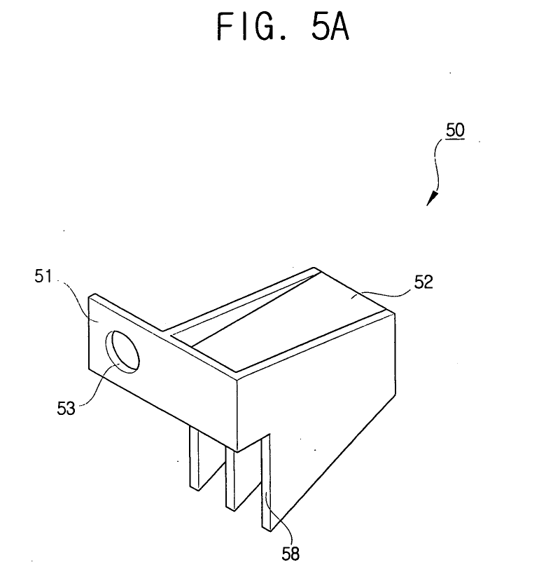

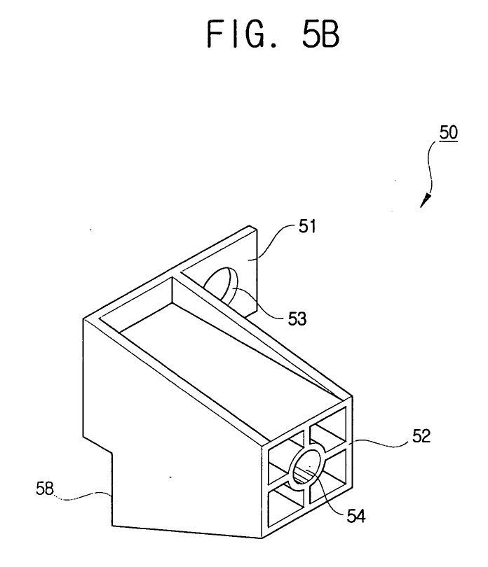

As is shown in FIGS. 5A and 5B, each coupling member 50 comprises a first coupler 51 extending from a first side thereof and coupling with the front casing 10. The second coupler 52 extends from a second side of the coupling member 50 and couples with the rear casing 30. A supporting groove 58 is provided between the first coupler 51 and the second coupler 52.

The first coupler 51 extends outward from the coupling member 50 and is coupled to the front supporter 11 of the front casing 10. Also, the first coupling holes 53 are positioned on a surface of the first coupler 51.

The first coupling holes 53 can communicate with the first bosses 13 of the front supporter 11 because the first coupling holes 53 are positioned coaxially with the first bosses 13 of the front supporter 11. Accordingly, the first screws 55 are inserted into the first coupling holes 53 and coupled to the first bosses 13 of the front supporter 11. Herein, although the first coupling holes 53 and the first bosses 13 are positioned coaxially, the first coupling holes 53 and the first bosses 13 are on axes spaced from axes of the second coupling holes 54 and the second bosses 31. (refer to FIG. 6)

The second couplers 52 are coupled to the rear casing 30, and are formed with the second coupling hole 54 depressed down from a surface thereof. The second coupling holes 54 are positioned on axes spaced from axes of the first coupling holes 53 and the first bosses 13, and are positioned coaxially with the second bosses 31 so that the second coupling holes 54 can communicate with the second bosses 31 of the rear casing 30. Accordingly, the second screws 38 are inserted through the second bosses 31, into the second coupling holes 54, thereby coupling the second bosses 31 of the rear casing 30 with the second couplers 52 of the coupling members 50 (refer to FIG. 6).

The supporting grooves 58 are respectively formed between the first couplers 51 and the second couplers 52, and function to support the coupling members 50 as they are locked on a top area of the panel supporting member 20.

Hereinbelow, an assembling process of the display apparatus 1 according to the embodiment of the present invention will be described. However, an assembly process may take an assembly order different from an assembly order described in this specification.

The LCD panel 23 is coupled to the panel supporting member 20 so that a circumferential area of the LCD panel 23 is supported by the panel supporting member 20. The panel supporting member 20 coupled to the LCD panel 23 is installed on an inner surface of the front casing 10 so that a displaying surface of the LCD panel 23 coupled to the panel supporting member 20 is exposed to the outside through the opening 12 of the front casing 10.

Also, the plurality of coupling members 50 are provided along a longitudinal direction on a top end of the panel supporting member 20 coupled to the LCD panel 23, and are spaced from each other with the first predetermined interval. Herein, the coupling members 50 are coupled to the top end of the panel supporting member 20 by plugging the supporting groove 58 of the respective coupling member 50 into the top end area of the panel supporting member 20. But it is understood that the supporting member 20 can be otherwise connected within the inner space.

Meanwhile, the top cover 40 and the rear casing 30 are coupled by inserting the rear coupling protrusions 33 formed on the inner surface of the upper area of the rear casing 30 into the insertion holes 43 formed on the coupling flanges 42 of the top cover 40.

When coupling the front casing 10 and the rear casing 30, firstly, each flange 15 of the front casing 10 and respective side area of the rear casing 30 are coupled using the third screws 39. In other words, the third screws 39 pass through the plurality of side coupling holes 35 formed on the respective side areas of the rear casing 30, and are coupled to the flange bosses 16 positioned on each flange 15 of the front casing 10.

Secondly, to couple a bottom area of the front casing 10 and a bottom area of the rear casing 30, the front coupling protrusions 14 formed on the bottom area of the front supporter 11 are inserted into and coupled to the protrusion accommodating bosses 37 formed on the bottom area of the rear casing 30.

As is shown in FIG. 6, the displaying surface of the LCD panel 23 is exposed to the outside through the opening 12 of the front casing 10. Accordingly, the front casing 10 is installed in the front, the top cover 40 is installed on the top, and the rear casing 30 is installed in the rear, centering the LCD panel 23 coupled to the panel supporting member 20.

In a case of coupling the top area of the front casing 10 and the top area of the rear casing 30, the top area of the front casing 10 and the top area of the rear casing 30 can be coupled by the coupling members 50 provided between the first bosses 13 and the second bosses 31 even if the first bosses 13 of the front casing 10 and the second bosses 31 of the rear casing 30 do not communicate with each other and are not coaxial, because the top cover 40 is installed in an angle to the front casing 10, as is shown in FIG. 6.

In other words, in a state that the top area of the panel supporting member 20 is coupled to the coupling members 50, the first screws 55 pass through the first coupling holes 53 and are coupled to the first bosses 13, as the first coupling holes 53 formed on the first couplers 51 of the coupling members 50 are positioned coaxially with the first bosses 13 positioned on the front supporter 11 of the front casing 10. Although the second coupling holes 54 formed on the second couplers 52 are spaced from axes of the first bosses 13 of the front supporter 11 installed coaxially with the first coupling holes 53, the second coupling holes 54 are positioned coaxially with the second bosses 31 of the rear casing 30. Accordingly, the second screws 38 are inserted through the second bosses 31, into the second coupling holes 54, coupling the rear casing 30 with the coupling members 50.

As is described above, in the display apparatus 1 according to the embodiment of the present invention, discharging holes 41 should be formed on the top cover 40 installed on the top of the LCD panel 23, to discharge the heat radiated from the inside of the display apparatus 1 rapidly, that is, to improve a heat discharging efficiency. Accordingly, the top cover 40 necessarily needs a large surface area. The embodiment of the present invention provides the display apparatus 1 improving the heat discharging efficiency while having a large surface area on the top cover 40 and a slim external appearance, because the top cover 40 is installed at an angle to the front casing 10.

Also, if the display apparatus 1 according to the embodiment of the present invention further comprises the coupling members 50, the first bosses 13 formed on the front casing 10 and the second bosses 31 of the rear casing 30 do not need to be positioned coaxially, because the coupling member 50 can be utilized for coupling.

As is described above, the embodiment of the present invention provides the display apparatus having an improved heat discharging efficiency to discharge heat radiated from the display apparatus rapidly and a slim external appearance.

While described in terms of a top cover, it is understood that the cover can be disposed on other sides of the display apparatus, between the front and rear casings 10 and 30.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A display apparatus comprising:
a display panel to display a picture;
a front casing provided in a front of the display panel;
a rear casing provided in a rear of the display panel and coupled with the front casing; and
a top cover provided on a top of the display panel in a predetermined angle to the front casing, and having a plurality of discharging holes positioned therethrough.

2. The display apparatus according to claim 1, further comprising a coupling member provided between the front casing and the rear casing and coupled with the front casing and the rear casing.

3. The display apparatus according to claim 2, further comprising:
at least one first boss, having a first axis and being positioned on an inner surface of an upper area of the front casing; and
at least one second boss, having a second axis and being positioned on an inner surface of an upper area of the rear casing, the second axis being spaced apart from the first axis of the first boss,
wherein the coupling member is provided between the first boss and the second boss, so that a first part of the coupling member is coupled to the first boss along the first axis, and a second part of the coupling member is coupled to the second boss along the second axis.

4. The display apparatus according to claim 3, wherein:
the first part of coupling member comprises a first coupler extending outward from a first side of the coupling member and having a first coupling hole positioned coaxially with the first boss to communicate with the first boss; and
the second part of the coupling member comprises a second coupler provided on a second side of the coupling member, positioned on an axis spaced from an axis of the first coupling hole, and having a second coupling hole positioned coaxially with the second boss.

5. The display apparatus according to claim 2, further comprising:
a panel supporting member coupled with a circumferential area of the display panel,
wherein the coupling member is provided plurally on an upper area of the panel support member along a longitudinal direction.

6. The display apparatus according to claim 5, wherein the coupling member has a supporting groove configured such that the coupling members are coupled to an upper end of the panel supporting member.

7. The display apparatus according to claim 3, further comprising:
a panel supporting member coupled with a circumferential area of the display panel,
wherein the coupling member is provided plurally on an upper area of the panel support member along a longitudinal direction.

8. The display apparatus according to claim 7, wherein the coupling member has a supporting groove configured such that the coupling members are coupled to an upper end of the panel supporting member.

9. The display apparatus according to claim 4, further comprising:
a panel supporting member coupled with a circumferential area of the display panel,
wherein the coupling member is provided plurally on an upper area of the panel support member along a longitudinal direction.

10. The display apparatus according to claim 9, wherein the coupling member has a supporting groove configured such that the coupling members are coupled to an upper end of the panel supporting member.

11. The display apparatus according to claim 1, wherein:
the top cover comprises a plurality of coupling flanges, each having an insertion hole positioned through a surface thereof, the plurality of coupling hinges being positioned along a circumferential area of the top cover contacting the rear casing; and
the rear casing comprises a corresponding plurality of coupling protrusions, the plurality of coupling protrusions being inserted into and coupled with the respective insertion holes.

12. The display apparatus according to claim 11, wherein:
the top cover comprises a coupling rib positioned on a surface of the top cover contacting the front casing; and
the front casing comprises a rib accommodating part with which the coupling rib is coupled.

13. The display apparatus according to claim 2, wherein:
the top cover comprises a plurality of coupling flanges, each having an insertion hole positioned through a surface thereof, the plurality of coupling flanges being positioned along a circumferential area of the top cover contacting the rear casing; and
the rear casing comprises a corresponding plurality of coupling protrusions, the plurality of coupling protrusions being inserted into and coupled with the respective insertion holes.

14. The display apparatus according to claim 13, wherein:
the top cover comprises a coupling rib positioned on a surface of the top cover contacting the front casing; and
the front casing comprises a rib accommodating part with which the coupling rib is coupled.

15. The display apparatus according to claim 1, wherein:
the top cover is approximately shaped like a triangle; and
a cross section of the rear casing is ‘V’-shaped, to correspond to a shape of the top cover.

16. The display apparatus according to claim 15, wherein the front casing comprises:
a front supporter having an opening exposing a displaying surface of the display panel to the outside; and
a pair of flanges extending from opposite ends of the front supporter, respectively, and coupling with opposite side areas of the rear casing, respectively,
wherein the pair of flanges are installed in a predetermined angle to the front supporter corresponding to a shape of the rear casing.

17. The display apparatus according to claim 16, further comprising a plurality of first bosses provided on an inner surface of an upper area of the front supporter along a longitudinal direction, the first bosses being spaced apart from each other with a first predetermined interval.

18. The display apparatus according to claim 4, wherein:
the top cover is approximately shaped like a triangle; and
a cross section of the rear casing is ‘V’-shaped, to correspond to a shape of the top cover.

19. The display apparatus according to claim 18, wherein:
the front casing comprises
a front supporter having an opening exposing a displaying surface of the display panel to the outside, and
a pair of flanges extending from opposite ends of the front supporter, respectively, and coupling with opposite side areas of the rear casing, respectively; and
the pair of flanges are installed in a predetermined angle to the front supporter corresponding to a shape of the rear casing.

20. The display apparatus according to claim 19, further comprising a plurality of first bosses provided on an inner surface of an upper area of the front supporter along a longitudinal direction, the first bosses being spaced apart from each other with a first predetermined interval.

21. A display apparatus, comprising:
a first casing;
a second casing;
a display panel to display a picture, disposed between the first and second casings; and
a cover disposed at a first predetermined angle to the first casing, between the first and second casings, and having a plurality of discharging holes, to discharge heat from the display apparatus.

22. The display apparatus according to claim 21, wherein the first casing comprises:
a first supporter having an opening communicating with the display panel; and
a pair of flanges projecting from opposing sides of the first supporter, to be connected with corresponding side areas of the second casing.

23. The display apparatus according to claim 22, wherein the display apparatus further comprises:
a panel supporting member connected with a circumferential area of the display panel and connected with the first supporter.

24. The display apparatus according to claim 23, further comprising:
at least one coupling member comprising a first coupler connected with the first casing, and a second coupler connected with the second casing.

25. The display apparatus according to claim 24, wherein:
the first supporter comprises
at least one first boss positioned on the first supporter and protruding toward the second casing,
at least one first coupling protrusion positioned on the first supporter and protruding toward the second casing; and
the second casing comprises
at least one second boss protruding toward the first casing,
at least one protrusion accommodating boss corresponding with the at least one first coupling protrusion and protruding toward the first casing;
the at least one protrusion accommodating boss is connected with the first coupling protrusion;
the at least one first boss is connected with the first coupler; and
the at least one second boss is connected with the second coupler.

26. The display apparatus according to claim 25, wherein:
the first casing comprises at least one flange boss positioned on at least one of the flanges and protruding toward the second casing; and
the second casing has at least one side coupling hole, through which a connector is inserted and connected with the at least one flange boss.

27. The display apparatus according to claim 25, wherein:
the cover comprises at least one coupling flange; and
the second casing comprises at least one second coupling projection connected with the coupling flange.

28. The display apparatus according to claim 25, wherein:
the cover comprises a coupling rib; and
the first supporter comprises a rib accommodating part that engages the coupling rib.

29. The display apparatus according to claim 24, wherein:
the at least one coupling member has a supporting groove positioned between the first and second couplers, to support the at least one coupling member on the panel supporting member when the at least one coupling member is connected with the first and second casings.

30. The display apparatus according to claim 21-, wherein the cover has a triangular shape.

31. The display apparatus according to claim 22, wherein:
the second casing has a v-shaped cross section; and
the pair of flanges extend from the first supporter at a second predetermined angle, to correspond with a shape of the second casing.

32. The display apparatus according to claim 21, wherein a first portion of the second casing has a first plurality of holes to discharge heat from the display apparatus, and a second portion of the second casing has a second plurality of holes through which air enters the display apparatus.

33. A display apparatus, comprising:
a first casing;
a second casing;
a display panel to display a picture, disposed between the first and second casings;
a cover disposed between the first and second casings at a first predetermined angle with respect to the first casing, and having a plurality of discharging holes to discharge heat from the display apparatus; and
a coupling member, connected at a first part thereof with the first casing, and connected at a second part thereof with the second casing.
